(19) United States
(12) Patent Application Publication
(10) Pub. No.: US 2010/0005986 A1
(43) Pub. Date: Jan. 14, 2010

(54) PRINTING PRESS OPERATING METHOD AND PRINTING PRESS

(75) Inventors: Minoru Sato, Hioshima (JP); Teruaki Shiromoto, Hioshima (JP)

Correspondence Address: KANESAKA BERNER AND PARTNERS LLP, 1700 DIAGONAL RD, SUITE 310, ALEXANDRIA, VA, 22314-2848, US

(73) Assignee: MITSUBISHI HEAVY INDUSTRIES, LTD., Tokyo (JP)

(21) Appl. No.: 12/446,369

(22) PCT Filed: Oct. 17, 2007
(86) PCT No.: PCT/JP2007/070250

§ 371 Date: Apr. 20, 2009

(30) Foreign Application Priority Data
Oct. 25, 2006 (JP) 2006-290440

(51) Int. Cl. B41F 13/54; B41F 33/00

(52) U.S. Cl. 101/228; 101/484

(57) ABSTRACT

A printing press operating method and a printing press capable of quickly stabilizing the tension of webs and improving cost effectiveness by reducing the amount of wasted paper are provided. An operating method of a printing press that is provided with a plurality of rollers on a web path, that conveys the web with these rollers, and that prints on the web with printing cylinders includes carrying out a tension-application operation for increasing the tension of the web while at least one of the rollers affecting the tension on the web, among the rollers provided on the web path, is set to an attached state with respect to the web and printing cylinders are set to a detached state, and then after this operation, accelerating the web to a printable state. In this way the tension of the web quickly stabilizes, and the amount of wasted paper can be reduced.

### TECHNICAL FIELD

The present invention relates to a printing press operating method and a printing press.

### BACKGROUND ART

Typically, a printing press capable of multicolor printing is configured of reel stand units for supplying webs; in-feed devices for applying appropriate tension to the webs; printing units; a web conveying device for conveying the webs, after printing, to a folding unit, splicing the webs, and carrying out printing alignment in the flow direction; and the folding unit for cutting and folding the webs into quires and conveying the quires.

For example, as described in Patent Document 1, such a printing press starts a printing operation after carrying out various adjustments in a low-speed region.

FIG. 3 illustrates the change in operating speed of a printing press according to the related art. First a crawling operation (crawling) is carried out for a short amount of time (a), and then feed out of a web begins. The crawling operation is a speed range in which, for example, preliminary supply of ink is performed, and the rollers, etc. are separated from the web in a detached state. None of the functions used in normal operation are used. Next, the rotational speed is increased and printing begins (b). At a color matching speed (60,000 copies per hour), a predetermined automatic registration operation (tone adjustment, and cutting position adjustment) begins (c). When accelerating from (b), the rollers, etc. enter an attached state. Then, the plate cylinder is installed, and all functions are enabled. In the automatic registration operation, the plate cylinder is aligned with respect to the registration mark positions of each other printed on the paper. The automatic registration process is completed within a predetermined amount of time from the beginning of the automatic registration operation (surface regulation completed), and the acceleration of the plate cylinder begins (d).

Patent Document 1:

Japanese Unexamined Patent Application, Publication No. 2003-52937

### DISCLOSURE OF INVENTION

It is known that with a printing press having such a configuration according to the related art, the tension of the webs is not stable while accelerating from the crawling operation. As a result, problems such as paper slipping and paper tearing may occur. Since the tension is not stable when the color matching speed is reached, there is a problem in that a certain amount of time is required for cutting to stabilize, and thus a large amount of wasted paper is produced.

The present invention has been conceived in light of the circumstances described above, and an object thereof is to provide a printing press operating method and a printing press capable of quickly stabilizing the tension of the webs and improving cost effectiveness by reducing the amount of wasted paper.

To achieve the above-described object, a first aspect of the present invention provides an operating method of a printing press that is provided with a plurality of rollers on a web path, that conveys the web with these rollers, and that prints on the web with printing cylinders, the method including running the web while at least one of the rollers affecting the tension on the web, among the rollers provided on the web path, is set to an attached state with respect to the web and printing cylinders are set to a detached state to carry out a tension-application operation for increasing the tension of the web, and then after this operation, accelerating the web to a printable state.

A second aspect of the present invention provides a printing press that is provided with a plurality of rollers on a web path, that conveys the web with these rollers, and that prints on the web with printing cylinders, the printing press including a controller for controlling the speed of the web and driving the rollers provided on a path of the web to be attached and detached with respect to the web, wherein the controller carries out a tension-application operation for increasing the tension of the web by conveying the web while at least one of the rollers affecting the tension of the web, among the rollers provided on the web path, is set to an attached state with respect to the web and printing cylinders are set to a detached state.

According to the first and second aspects, the tension acting upon on the webs is increased by the tension-application operation. By installing plate cylinders after sufficiently increasing the tension of the webs by this operation, the tension can be quickly stabilized. All rollers affecting the tension of the webs may be set to an operating state. However, a certain effect is achieved by setting at least some of the rollers to an operating state.

In this way, since the tension can be quickly stabilized, the amount of wasted paper at the beginning of printing can be reduced, and cost effectiveness can be improved.

In the first aspect, during the tension-application operation, the tension of the web may be measured and continued to be measured until the tension is greater than or equal to a predetermined threshold.

In the second aspect, a tension sensor for measuring the tension of the web may be further included, and the controller may increase the web speed when the tension of the web becomes greater than or equal to a predetermined threshold during the tension-application operation.

In this way, by carrying out the tension-application operation until the web tension reaches a predetermined threshold, the tension can be quickly stabilized during operation after the plate cylinder is installed.

By carrying out the tension-application operation before installing plate cylinders, the tension quickly stabilizes. As a result, problems such as paper slipping and paper tearing can be prevented, and cutting can be stably carried out. In this way, the amount of wasted paper can be reduced.

### BRIEF DESCRIPTION OF DRAWINGS

FIG. 1 is a schematic view illustrating, in outline, the structure of a web offset press according to an embodiment of the present invention.

FIG. 2 illustrates the operating speed of the web offset press and the tension of the webs.

FIG. 3 illustrates the operating speed and the tension of the webs of the web offset press according to the related art.

### EXPLANATION OF REFERENCE SIGNS

3: printing unit
7: web
9: web offset press control unit

### BEST MODE FOR CARRYING OUT THE INVENTION

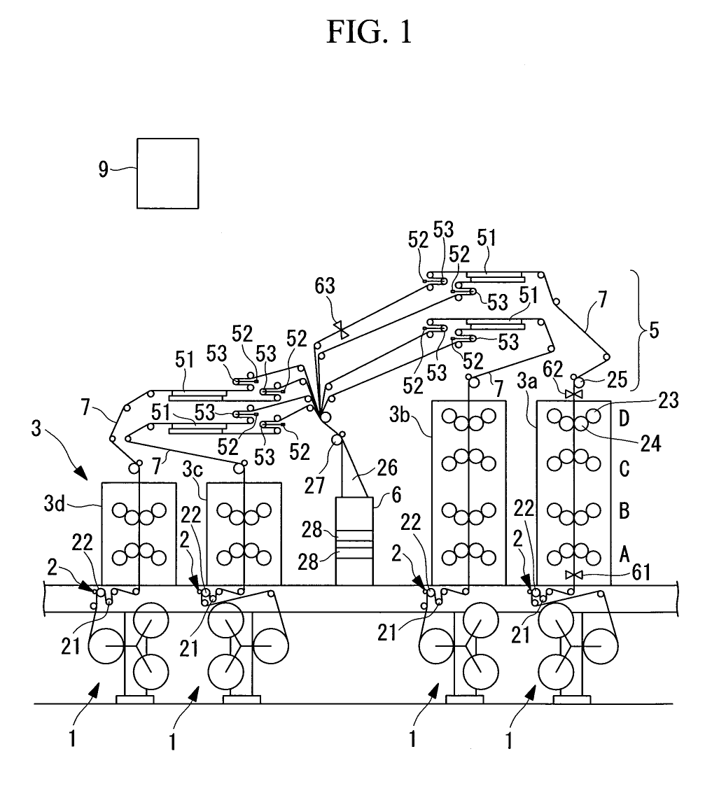

An embodiment of the present invention will be described below with reference to the drawings. This embodiment is an application of the present invention to a newspaper rotary press for multi-page duplex printing. FIG. 1 is a schematic view illustrating, in outline, the entire structure of an offset newspaper rotary press with a multi-page duplex printing/multi-color printing unit. The web offset press includes a plurality of reel stand units 1 for supplying webs 7; in-feed devices 2 for applying appropriate tension to the webs 7; printing units 3; a web conveying device 5 for conveying the webs 7, after printing, to a folding unit 6, splicing the webs 7, and carrying out printing alignment in the flow direction; the folding unit 6 for cutting and folding the webs 7 into quires and conveying the quires; and a web offset press control unit (controller) 9 for controlling the entire web offset press.

The reel stand unit 1 is configured to hold three paper rolls constituting the webs 7 wound into rolls. When paper is fed from a first paper roll, a second paper roll is in a paper-splicing preparation state, and a third paper roll is loaded. When the remaining amount of the web 7 on the first paper roll decreases, the web 7 on the second paper roll is spliced. While the web 7 is supplied from the second paper roll, the third paper roll is prepared for paper splicing. In this way, the web 7 is continuously fed from the reel stand unit 1 to the printing unit 3.

The in-feed device 2 is provided with a dancer roller 21 for carrying out tension control and an infeed drag roller 22 for drawing the web 7 from the reel stand unit 1. The infeed drag roller 22 is configured of a pair of rollers sandwiching the web 7. The dancer roller 21 is held in a swayable manner with an actuator that is not shown in the drawing. For example, when the actuator is an air cylinder, its air pressure is set to correspond to various operating and printing conditions. The air pressure of the air cylinder is variably adjusted when malfunctions, such as an imbalance in the webs during cutting-position adjustment, occur.

The number of units included in the printing units 3 corresponds to the number of printing colors. In this embodiment, printing units 3a to 3d are provided as the printing units 3. The printing units 3a and 3b are each provided with four printing units on both sides of the web for printing black, cyan, magenta, and yellow, in this order from the bottom. These colors are mixed to perform color printing. Similarly, the printing units 3c and 3d are each provided with two printing units for printing black and one other color.

Describing in outline the structure of the printing unit 3a as a representative example, the printing units print the four colors black, cyan, magenta, and yellow on the web 7. Printing on the web 7 means printing in the same area on the web 7 that is continuously flowing. In this way, the colors overlap in the same area to form one image, enabling multicolor printing of the image.

The printing units A to D constituting the printing unit 3a include devices functioning as various rollers, such as bracket cylinders 24 and plate cylinders 23. Motive energy from a common motor is supplied to these various devices. Ink devices and dampening devices (not shown) are provided around the plate cylinders 23.

These printing units 3 are merely examples, and any appropriate printing units may be employed, such as single-color printing units for carrying out duplex monochrome printing or printing units for carrying out four-color printing on one side and two-color printing on the other side.

The printing units 3 carry out predetermined printing on the webs 7 supplied from the reel stand units 1 and supply the webs 7 to the web conveying device 5. The web conveying device 5 includes many turn bars 51 and is configured to change the running routes of the webs 7 from the printing units 3 such that the stacking order thereof can be changed. The width of the webs 7 is equal to the width of four pages of a regular newspaper. The webs 7 illustrated in the drawing are cut with a slitter at the center in the width direction after printing. Then the two-page-wide web 7 on one side in the width direction is stacked on the two-page-wide web 7 on the other side at the turn bars 5. In this way, the web 7 entering the folding unit has eight layers, and 32-page printed material, i.e., eight sheets of newspaper each having four pages (two pages on each side) is ejected to one side of the folding unit 6. Printing-unit drag rollers 25 for holding the web 7 and applying tension to the upstream web 7 by rotating at a speed faster than the upstream side are provided near an outlet of the printing unit 3.

The folding unit 6 is configured to stack the plurality of webs 7 sent from the web conveying device 5 and eject desired fold sections by longitudinal cutting, longitudinal folding using a former 26, lateral cutting, and/or lateral folding. An air blower (not shown) is provided near the former 26 and separates the webs 7 from the former 26 by blowing air. Folding-unit drag rollers 27 for applying tension to the upstream webs 7 are provided forward of the former 26. Nipping rollers 28 for pulling the webs 7 downstream are provided inside the folding unit 6.

When the webs 7 are directly guided into the folding unit 6, without cutting with a slitter at the center in the width direction after printing and stacking them one on the other, 16-page newspapers can be ejected to both sides. There is a device for switching and delivering the webs, after printing at the printing units 3a and 3b capable of color printing, to any position. This device, however, is not illustrated. To increase the number of pages, another web 7 is introduced from an adjacent printing unit. When the number of pages is small, e.g., when three of the printing units 3 are used, the path to the folding unit 6 of a web 7 printed at a printing unit 3 differs depending on which three printing units 3 are selected.

In this way, the lengths of the webs 7 from the printing units 3 to the folding unit 6 may vary depending on the operating pattern. When the tension associated with the web 7 varies, the degree of extension of the web 7 changes. Therefore, the length of the web 7 from the printing unit 3 to the folding unit 6 varies.

If the length of the web 7 from the printing unit 3 to the folding unit 6 varies in this way, the cutting position of the folding unit 6 changes. Therefore, the web 7 cannot be cut at a predetermined position.

The web offset press according to this embodiment includes compensator rollers 53 for changing the running-route length of the webs 7 and adjusting the cutting positions. Each compensator roller 53 is equipped with moving means 52 for moving it, supporting means, and a position detecting device, such as a potentiometer.

The web offset press control unit 9 is a device for controlling the entire printing press. The web offset press control unit 9 has a function for attaching and detaching rollers, such as the infeed drag rollers 22, the printing-unit drag rollers 25, the folding-unit drag rollers 27, and the nipping rollers 28, to and from the webs 7 by driving the actuator (not shown).

A tension pick (tension sensor) 61 is provided at the inlet section of the printing unit 3; a tension pick (tension sensor) 62 is provided at the outlet section; and a tension pick (tension sensor) 63 is provided between the compensator roller 53 and the folding-unit drag roller 27. The tension picks 61, 62, and 63 measure the tension of the web 7 at the corresponding sections and transfer information thereof to the web offset press control unit 9. Tension picks may be provided at other locations when needed.

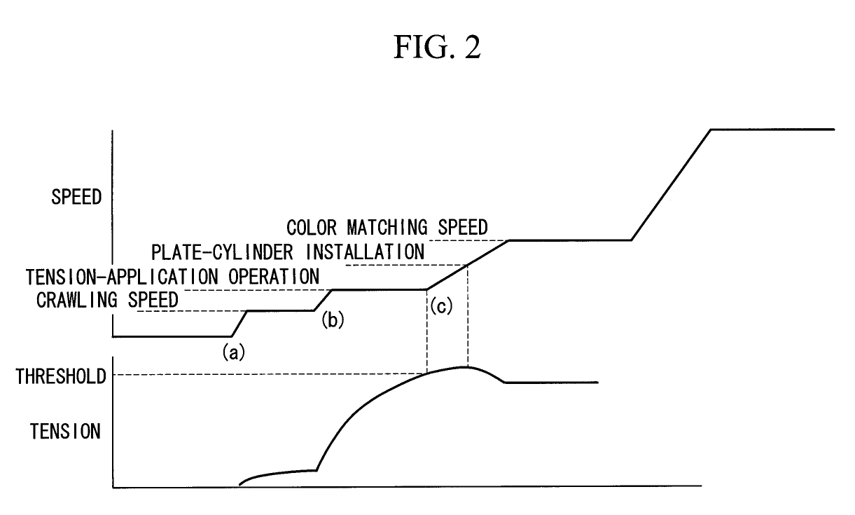

FIG. 2 illustrates the operation control of the web offset press control unit 9 of the rotary printing press.

First, a crawling operation is carried out (a). The crawling operation is an operation for paper feeding, preliminary supply of ink, presetting each unit, etc. In the crawling operation, rollers, such as the cylinders in the printing units 3, the infeed drag rollers 22, the printing-unit drag rollers 25, the folding-unit drag rollers 27, and the nipping rollers 28, are in a detached state (separated from the webs 7). An air blow of the former 26 and the paper-feeding-tension control device provided in the in-feed devices 2 are also in a deactivated state.

After carrying out the crawling operation for a predetermined amount of time, a tension application operation begins (b). In the tension application operation (b), the above-mentioned rollers, excepting the printing cylinders (such as the bracket cylinders 24 and the plate cylinders 23), are in a state attached to the webs 7, and the all auxiliary devices, such as the air blow of the former 26, are in the same state as the operating state. (In this embodiment, all auxiliary devices are in an operating state. It is possible, however, to achieve a certain effect by setting at least some of the elements affecting the tension, excluding the printing cylinders, to the operating state.)

In this state, since the rollers are in an attached state, the tension of the webs 7 increases as shown in FIG. 2. For example, when the tension is greater than or equal to a predetermined threshold, acceleration is carried out to transit to the color matching speed (for example, 60,000 copies per hour) (c).

The threshold is set for each of the tension picks 61, 62, and 63, and the web offset press control unit 9 is accelerated when all of the detected tensions of the tension picks 61, 62, and 63 exceed the threshold. The acceleration timing may be determined by selecting one representative tension pick from the tension picks 61, 62, and 63.

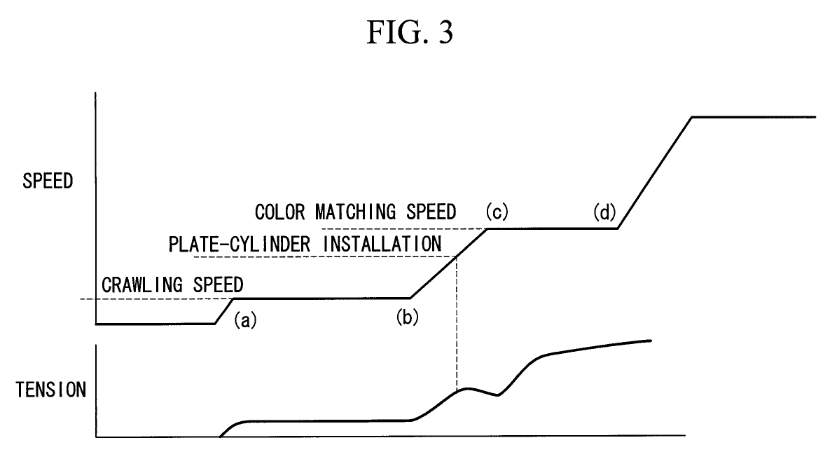

FIG. 3 illustrates the relationship between speed and tension in an operating method according to the related art. As shown in the drawing, since the rollers are in a detached state during the crawling operation, tension does not act upon the webs 7, and the increase of tension is gradual even when acceleration is started from the crawling operation. Since the tension decreases due to the ink when the plate cylinders are installed, the tension will be even more unstable if the plate cylinders are installed while the tension is low. It has been discovered that this is the cause of paper slipping and paper tearing, which are problems of the related art. Since tension is not stabilized even when the color matching speed (60,000 copies per hour) is reached, time was required for the cutting to stabilize, and a lot of wasted paper was produced.

In this embodiment, by carrying out operation with all auxiliary devices, excepting the printing cylinders, in an operating state during a temporary tension-application operation, the tension quickly stabilizes, and acceleration begins when the tension reaches a threshold at which the tension stabilizes. Therefore, even when plate cylinder are installed in such a manner that tension is decreased, the tension does not become unstable, and thus, problems such as paper slipping and paper tearing can be prevented while carrying out stable cutting. In this way, the amount of wasted paper can be reduced.

The tension-application operation in this embodiment is carried out at a speed higher than the speed for carrying out the crawling operation but may be any speed that applies tension to the webs in the low-speed state before printing. In the above, the web offset press control unit 9 carried out automatic control. However, the tension-application operation may be carried out manually. If the tension does not reach the threshold within a predetermined amount of time, acceleration (c) may be carried out before reaching the threshold.

1. An operating method of a printing press that is provided with a plurality of rollers on a web path, that conveys the web with these rollers, and that prints on the web with printing cylinders, the method comprising:
running the web while at least one of the rollers affecting the tension on the web, among the rollers provided on the web path, is set to an attached state with respect to the web and printing cylinders are set to a detached state to carry out a tension-application operation for increasing the tension of the web, and then after this operation, accelerating the web to a printable state.

2. The operating method of a printing press according to claim 1, wherein, during the tension-application operation, the tension of the web is measured and continued to be measured until the tension is greater than or equal to a predetermined threshold.

3. A printing press that is provided with a plurality of rollers on a web path, that conveys the web with these rollers, and that prints on the web with printing cylinders, the printing press comprising:
a controller that controls the speed of the web and driving the rollers provided on a path of the web to be attached to and detached from the web,
wherein the controller carries out a tension-application operation for increasing the tension of the web by conveying the web while at least one of the rollers affecting the tension of the web, among the rollers provided on the web path, is set to an attached state with respect to the web and printing cylinders are set to a detached state.

4. The printing press according to claim 3 further comprising:
a tension sensor for measuring the tension of the web,
wherein the controller increases the web speed when the tension of the web becomes greater than or equal to a predetermined threshold during the tension-application operation.
